(19) United States
(12) Patent Application Publication
(10) Pub. No.: US 2008/0076556 A1
(43) Pub. Date: Mar. 27, 2008

(54) Simulated 3D View of 2D Background Images and Game Objects

(75) Inventor: Emmanuel G.A. Icart, Coignieres (FR)

Correspondence Address: LEE & HAYES, PLLC, 421 W. RIVERSIDE AVE, STE 500, SPOKANE, WA, 99201, US

(73) Assignee: BIG FISH GAMES, INC., Seattle, WA (US)

(21) Appl. No.: 11/618,677

(22) Filed: Dec. 29, 2006

Related U.S. Application Data
(60) Provisional application No. 60/826,706, filed on Sep. 22, 2006.

(51) Int. Cl. A63F 13/00

(52) U.S. Cl. 463/32

(57) ABSTRACT

A video computer game is described that changes an apparent view of a portion of a two dimensional image to simulate up to a 360 degree panning in three dimensional virtual space in response to signals from a user input device. An indication may then be provided, in response to signals from the user input device, of a selection of displayed virtual objects layered on the portion of the two dimensional image.

### PRIORITY

This application claims the benefit of U.S. Provisional Application No. 60/826,706, filed Sep. 22, 2006.

### BACKGROUND

Currently, virtual players in computer games move to different locations within the games. When the virtual players move within the game, the background objects as well as the virtual player is typically re-drawn in three dimensions using triangles or polygons. Redrawing may require substantial processing power which is not always available on portable computing devices, or may require a large amount of computer memory to play the game.

### SUMMARY

Computer implemented games are described that enable a user to effect the game using an input device. Using the input device, the user changes an apparent view of a portion of a two dimensional (2D) background image to simulate a 360 degree panning of the image in three-dimensional (3D) virtual space. Also in response to signals from the user input device, a selection of displayed 2D virtual objects layered on the portion of the two dimensional image is indicated.

This summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 depicts an illustrative process in which images used in a video game can be joined together.

FIG. 2 depicts an illustrative process for adding virtual objects to video game images.

FIGS. 3a-3b depicts an illustrative process for mapping and/or rendering a video game image from two-dimensional space to three-dimensional space.

FIGS. 4a-4b depicts an embodiment of the game display as it pans from one apparent view to another.

FIGS. 5a-5b depicts an embodiment of the game display as it pans from one apparent view to another using a virtual control object.

FIG. 6 is an illustrative flow chart of the game that simulates 3D viewing using 2D images.

FIG. 7 is an embodiment of a computer environment on which the game system can operate.

### DETAILED DESCRIPTION

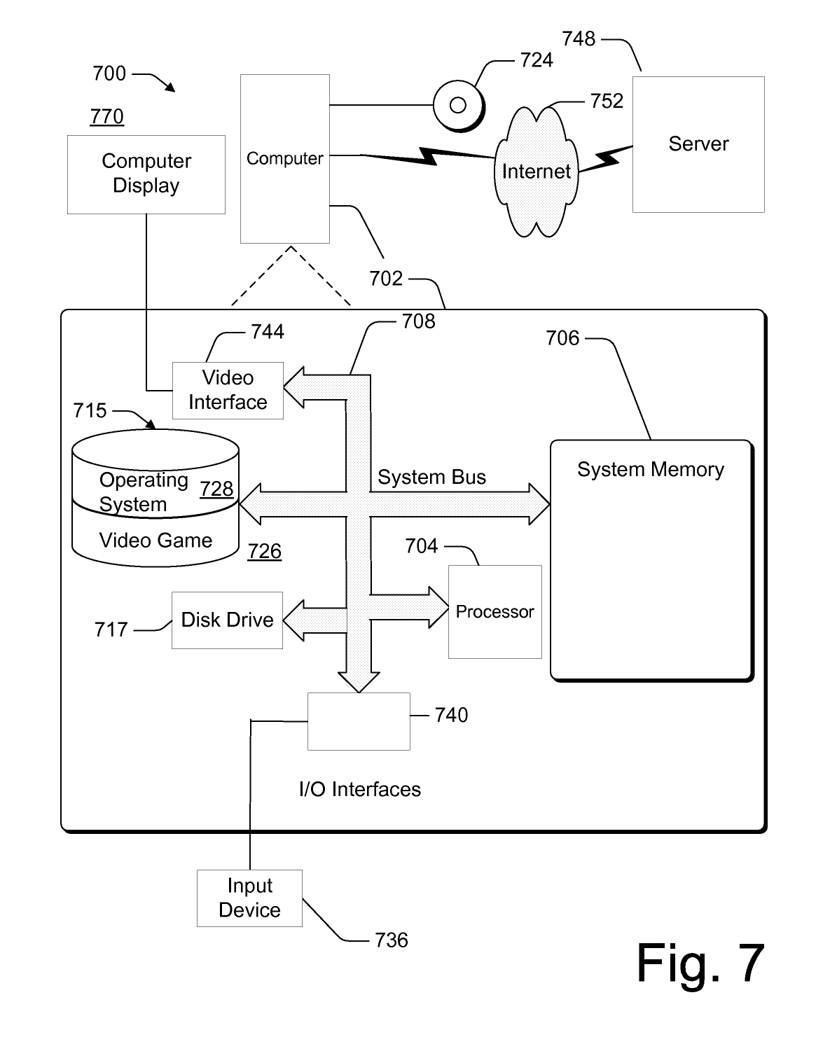

The following document describes method(s) or software capable of instantiating a computer video game. The video game may be executed on any electronic device such as a computer, PDA, computer laptop or gaming device (See FIG. 7). The computer game software is operable to enable a game user to pan and change an apparent view of a portion of a two dimensional image in virtual space of background scenery in the video game. The view of the two dimensional image may be changed in response to signals from a user input device so that the image can be panned in 360 degrees horizontally and vertically to appear to have a complete 360 degree of view. Layered on the image are virtual objects that may be selected by the game user. In response to one of the objects being selected, an indication of the selection may be provided to the game user.

The construction of the video game and an environment in which this video game may be enabled by techniques is set forth first below. This is followed by others sections describing various inventive techniques and illustrative embodiments of other aspects of the video game.

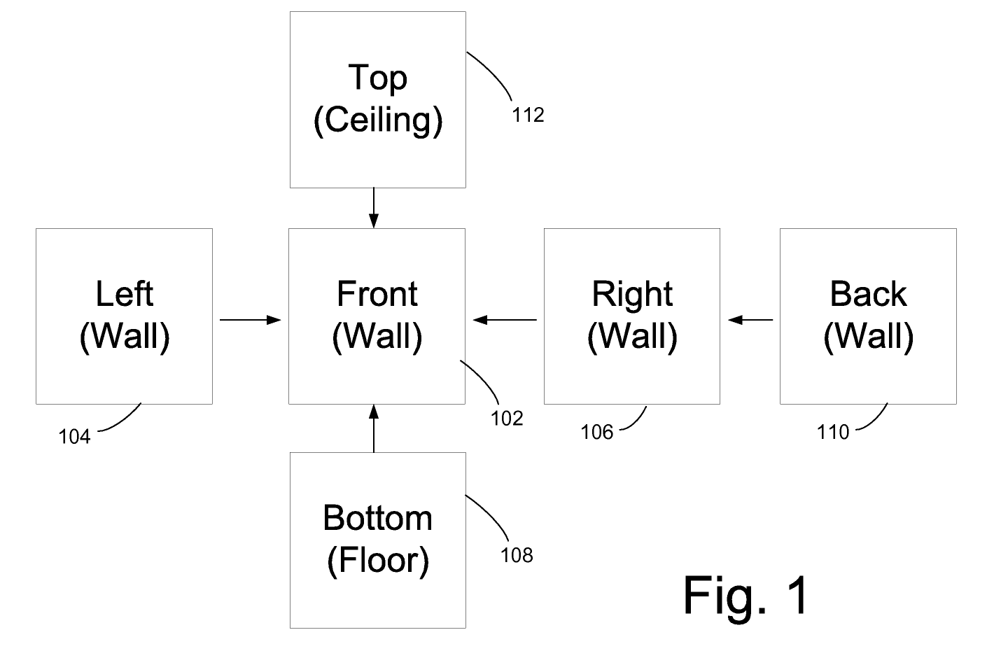

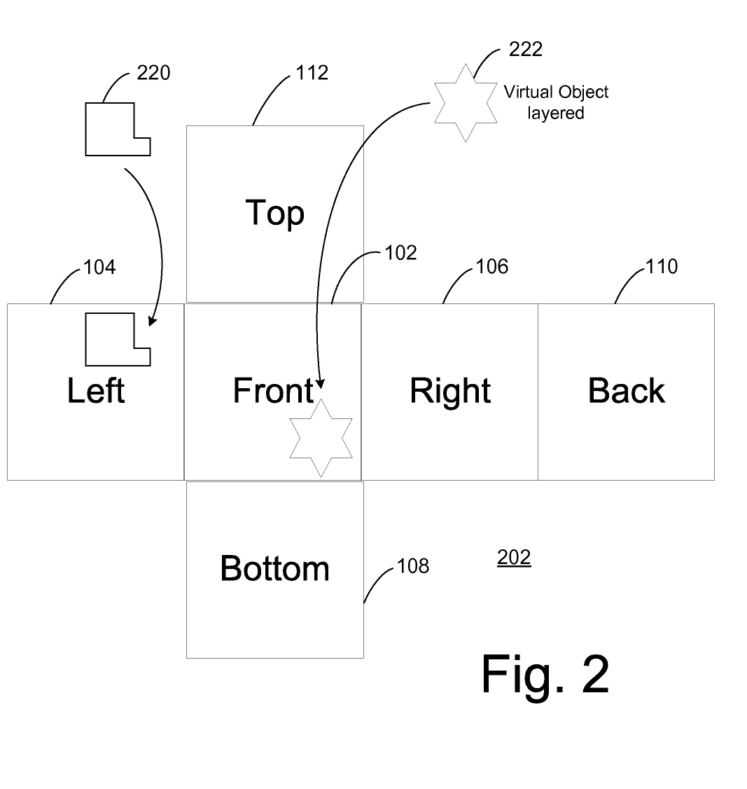

Referring to FIG. 1, a panoramic view of multiple images (102-112) is depicted. Each image comprising a two dimensional image, which may be stitched together using generally known stitching programs (such as RealViz Stitcher software by Realviz Inc. of Sophia—Antipolis, France) to form a combined virtual image 202 (FIG. 2) for use in the video game. Images 102-112 may be comprised of photographs, animation, art, video stills or artwork and may be stored in a computer in any known image format, examples include but are not limited to, JPEG, Bit Map (BNP), GIF, TIFF or RAW.

Images 102-112 preferably are created using various products or software, examples of which may include a camera, drawing software products or animation software products. A first step to create the images is to make either panoramic photographs or multiple photographs of a room or scene, where image 102 may correspond to a front wall, image 104 may correspond to a rear wall, image 106 may correspond to a rear wall, image 108 may correspond to a bottom or floor, image 110 may correspond to a back wall, and image 112 may correspond to a top wall, sky or ceiling. Although each of images 102-112 are shown as a single image, images 102-112 could each be constructed from multiple photographs depending on light, exposure, scene, and geometry of the location where each of the photographs are taken. Further these photographs do not have to be taken in a specific order, and their “position” may not fit a deployed cube shape like the illustrative cube shown in FIGS. 1-3 but rather may form the walls of any geometric shape examples of which may include a polyhedron or a tetrahedron.

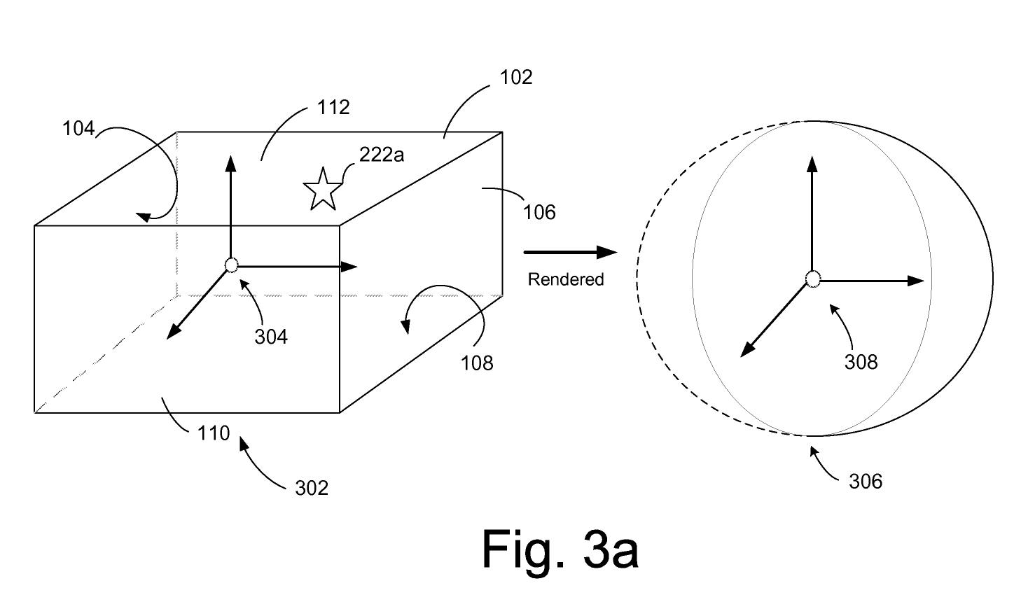

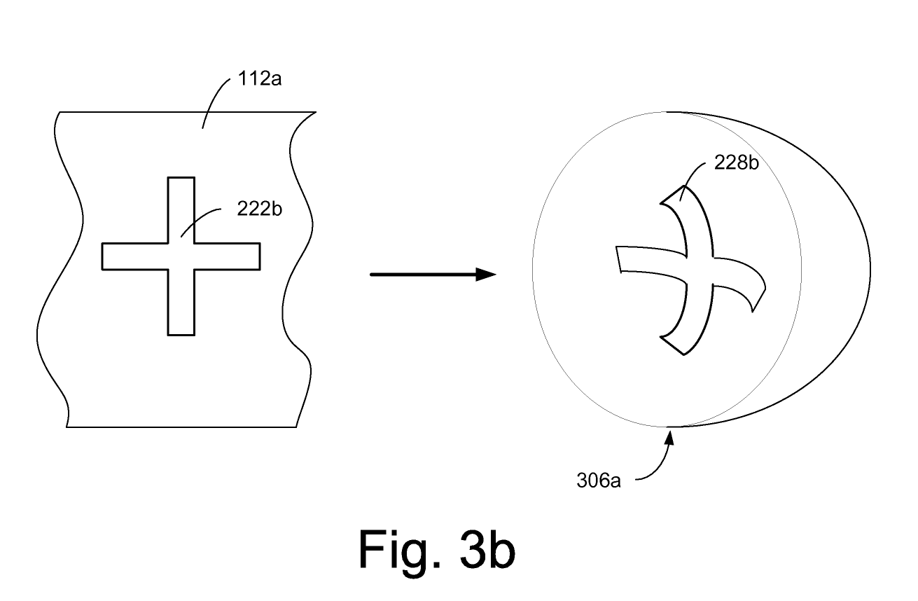

Depicted in FIG. 2 is combined virtual image 202 that includes images 102-112 stitched together and mapped to form the sides for cube 302 (FIG. 3a). A virtual cube 202 may be constructed from the stitched images 102-112 using generally known products such as Cubic Converter, which is available from Apple Computer Corp. of Cupertino Calif. One or more virtual objects 220 and 222 may be layered over the combined virtual image 202 or may be layered over one or more of images 102-112 before images 102-112 are stitched together.

Referring to FIG. 3a, virtual cube 302 may be viewed from its center location 304 during the play of the video game. When images 102-112 form the walls of the virtual cube 302 and are rendered, the images and object 222a would appear to the game user as a background. During game play, the game user may pan through the images to simulate a 360 degree view. Preferably a three dimensional (3D) rendering program is used to provide the prospective of a sphere 306 when viewing the walls of cube 306 from its center 308.

Referring to FIG. 3b, the sample image 112a may be rendered using the rendering program. Image 112a is rendered by mapping a 2D image, shown on a wall 112 of cube 302, onto the inner surface of a 3D geometric shape. Image 112a is shown mapped onto partial sphere 306a for the purposes of demonstration. Object 222b may be layered on image 112a and could likewise be rendered on a portion of sphere 306a. Similarly each of the other images on the walls of cube 302 (along with any objects layered on the other images) could be rendered onto a portion of sphere 306.

A rendering engine program could be used to provide the prospective of a sphere, cylinder, cone, pyramid or any multidimensional 3D object. Such rendering engine programs may be constructed using a Microsoft DirectX library, or the Open GL Library, where the cube for the engine is constructed from a set of 12 triangles (two triangles for each side of the cube), and where the engine uses a core formula that deals with rendering a triangle using perspective correct texture mapping. A full software renderer could be used, for computers which do not have a 3D graphics card, or insufficient 3D capabilities. In that case, the rendering engine program could use known 3D mathematics to render each one of the triangles.

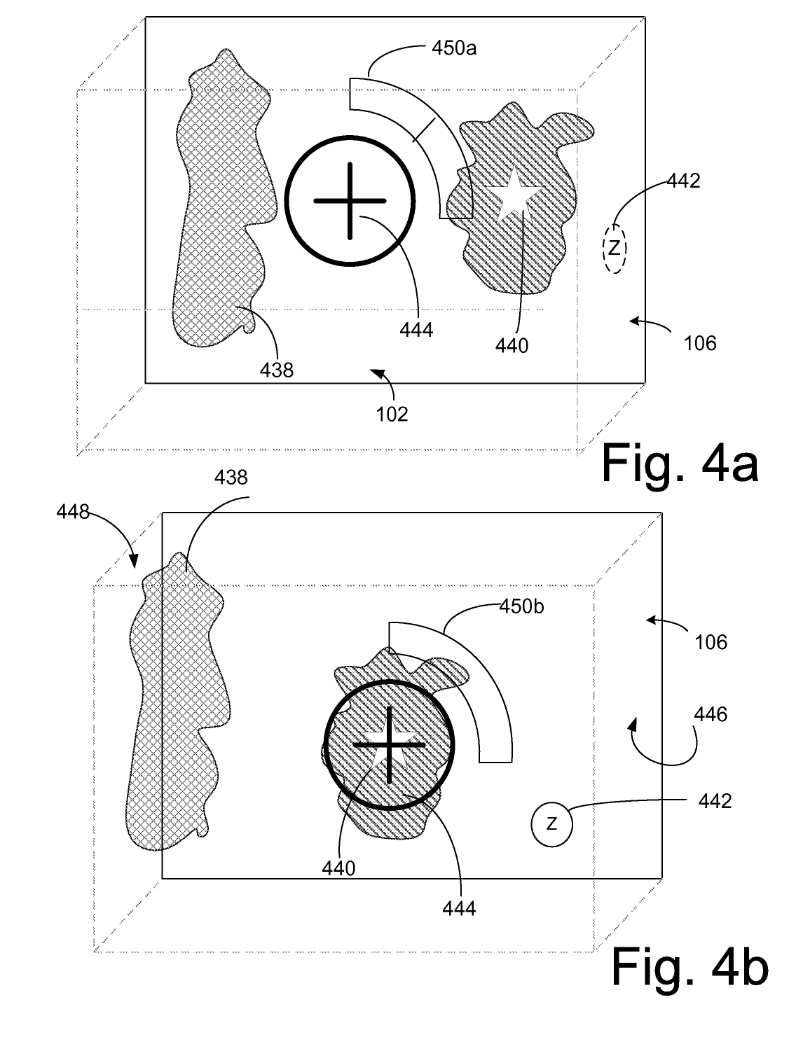

Illustrated in FIG. 4a is an apparent view of a portion of the video game having a front wall image 102, overlaid with visual virtual objects 438 and 440, and right wall image 106 overlaid with virtual object 442. Object 442 may not be visible to the game player and is shown in phantom on non-visible wall image 106. Although the points on the virtual image on front wall image 102 are shown residing in the same plane, a rendering engine could be used to render images 102-112 that would result in the images appearing to the game player to reside on all the walls of a cube (or a sphere) to enable the room to be panned so that the room can be viewed in a 360 degree (or less) angle. Also overlaid over front wall 102 is target sight 444 which can appear to be moved over objects 438 or 440 in response to signals from a user input device 736 (FIG. 7).

In one embodiment target sight 444 may be constantly maintained in the center of the display to the game user, also referred to as the game player's field of view. In response to signals from user input device 736, the apparent view of the image 102 is moved to show at least a portion of the image on one of the other wall images, such as wall image 106 (FIG. 4b). The apparent view of the wall images may appear to be moved to simulate panning of the images. Simulation of panning may be at any angle up to 360 degrees on either a horizontal or vertical axis. The apparent view of the images may also be changed to zoom into or out from the image. Further, the virtual objects 438, 440 and 442 may appear to move when the image 736 is panned.

Referring to FIG. 4b, when the image 102 is panned, virtual objects 438-442 appear to be moved, and object 438 appears to move to non-visible side wall 448 such that object 438 may no longer be visible, while object 440 appears to be moved into a position where it is centered on target sight 444. Also when image 102 is panned, object 442 would appear to be moved to a position where it would now be viewable on visible wall 446.

When the image 102 and target sight 444 is panned such that target sight 444 overlays an object, such as object 440, the object 440 may now be selected. Such selection may occur by generating a selection indication with input device 736 (e.g. in response to a game user clicking on a mouse or selecting a pre-selected key of an input device) and the input device 736 providing a signal to the video game program.

When such selection of the object occurs, an indication may be provided to the game user. Such indication may be provided by causing the object to vanish, having animation occur around the object, indicating an item is removed from a list, moving or highlighting the object, or providing information about a room or a location where the virtual object exists in virtual space.

Referring again to FIG. 4a there is shown a target sight 444 overlaid on the portion of the two dimensional image 102 along with target sight proximity locator 450a. Target sight proximity locator 450a indicates the apparent proximity of a virtual object to be selected (also referred to as a target virtual object) with respect to the target site when the apparent view is changed. The target sight proximity locator 450a may indicate or hint of a close proximity of a target object to the target sight by being in the form of an expanding and contracting bar indicator. The proximity locator 450a may be positioned adjacent to the target sight 444. The bar provides an indication by increasing or decreasing in length as the proximity of target sight 44 moves closer or further away from the virtual target objects in virtual space. Referring to FIG. 4b, in one embodiment target sight 444 is positioned over object 440 and proximity locator 450b displays a bar at its peak length.

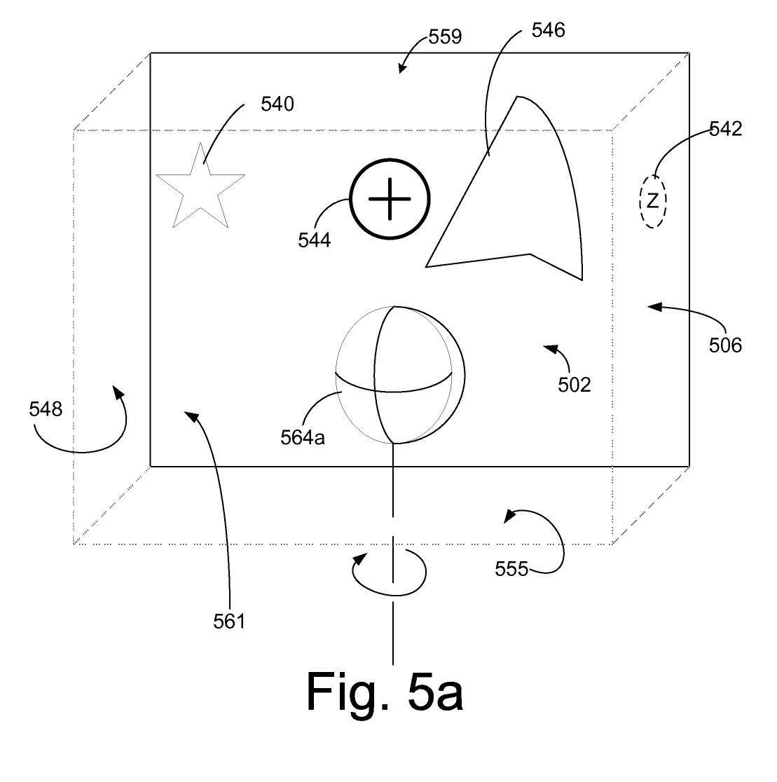

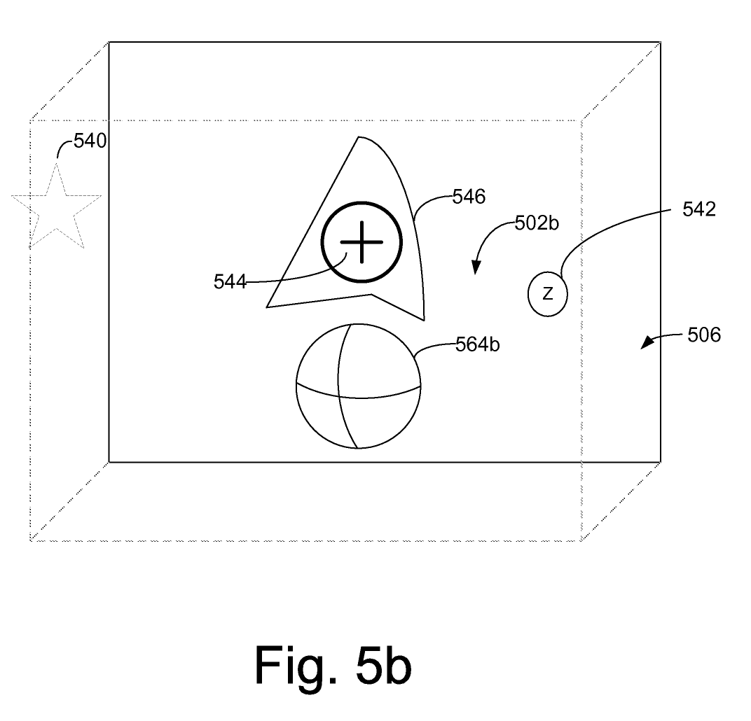

Depicted in FIG. 5a is apparent image 502 with visible virtual objects 540 and 546, and not visible object 542 on image 506. A virtual control object 564a that may be rotated is shown simultaneously with the apparent image 502. Virtual control object 564a may be formed in a shape corresponding to the apparent shape provided by the rendering engine. As shown, for example, the control object may be shown in the shape of a sphere and may have particular markings that rotate when the control object rotates 564a. Control object 564a may be rotated in response to a user selection of the object 564a with a user input device 736. Control object 564a may be configured to rotate at an angular velocity proportional to a speed in which a user input device, such as a mouse or a track ball moves and/or rotates. Control object 564a may, in one embodiment, be rotated in up to 360 degrees, in a clockwise or counter clockwise direction in the x, y or z plane. When virtual control object 564a is rotated, the apparent view of the combination images 502, 506, 548, 555, 559, and 561, and objects (540, 542 and 546) overlaid thereon, for example, may be change to appear to rotate proportionately to the angle and velocity of rotation of the virtual control object 564a.

For example, depicted in FIG. 5b, control object 564b is shown to have rotated a few degrees counterclockwise with respect to control object 564a (FIG. 5a). Image 502b appears to have rotated proportionately with the rotation of control object 564a, and object 540 appears to have rotated onto wall 66 and would no longer be visible where object 542 appears to be rotated onto wall 502b and is now visible. In addition virtual object 546 may be rotated to coincide with target site 544. Although the projected images in FIGS. 4-5 are depicted in the shape of a cube, the appearance to the game player may be that of a view from inside of a sphere or any of the aforementioned geometric 3D objects.

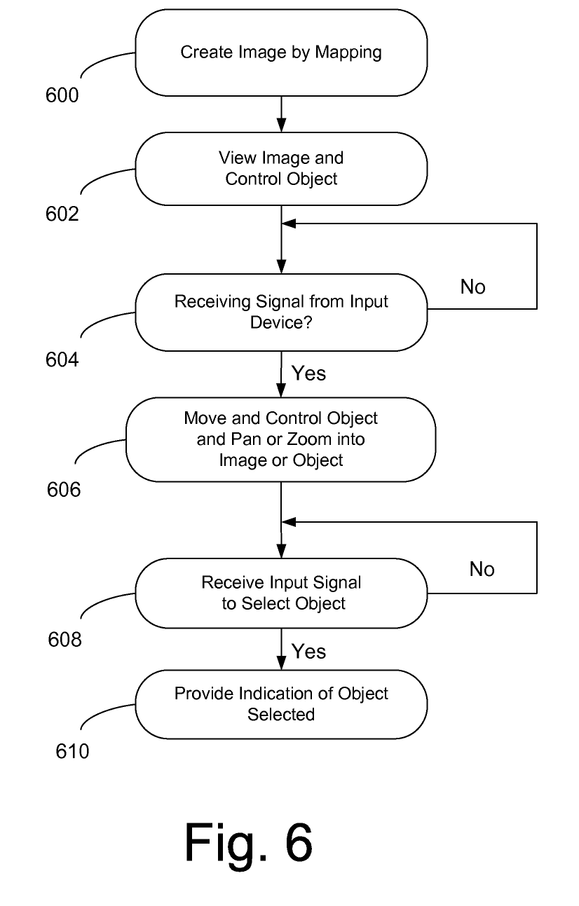

Depicted in FIG. 6 is a flowchart 600 showing the process to create and play the computer video game using the techniques described in FIGS. 1-5. In block 600, the two dimensional images 112-122 (FIG. 1) used during play of the video game are stitched together to form the walls of a cube 302. Each image on the cube 302 wall may then be mapped to a portion of an inner wall of a sphere (or the walls of any other geometric 3D object), with the combination of all images 112-122 covering then entire sphere to create a background image for the computer game in 3D virtual space. The images are mapped using generally known mapping and rendering techniques. Virtual objects, such as sample objects 540, 542 and 546 (FIG. 5a) may also be overlaid on the images forming the walls before the images are mapped onto the sphere, or alternatively objects may be overlaid on the resulting images after the images are mapped.

In block 602, a portion of the mapped images along with the overlaid virtual objects may be displayed as a background to the game player to provide the perception that the game player is viewing the images from the center 308 of the sphere (See FIG. 3). In addition a small spherically shaped (or any other geometric 3D control object, preferably one the same shape as the geometric object in which the cube is mapped) control object 564 may be simultaneously be displayed to the game player along with the images. In one embodiment a target site proximity locator may be displayed to indicate a proximate position of a target object with respect to a target site. The proximity locator may depict a bar that appears to grow as a distance between the target site and the target object appears to be reduced, and the bar may appear to shrink as the distance appears to increase.

In block 604, the computer video game determines if it has received a signal from an input device 736 to the game. This signal may indicate either to rotate the control object 564 (thus simulate a panning effect), or to zoom into or out of the image. If the signal is received indicating rotation of the control object 564, in block 606 the control object 564 may appear that it has rotated and the background image is panned in the same direction the control object 564 appears to rotate. The control object 564 may be rotated (resulting in the background image being panned and the virtual objects layered on the background images also being panned) in the vertical direction (along a y-axis), in the horizontal direction (along an x-axis) or in a direction perpendicular to the plane formed by the x and y axis (along a z-axis). Also the angular velocity the control object 564 is rotated may be proportional to the velocity the background image is panned. If the signal from input device 736 indicates a zoom in or zoom out, the background image may be enlarged are shrunk proportionally.

In block 608, the computer video game determines if it has received a signal from an input device indicating that a virtual object has been selected. A target site 444 may be placed in a fix position on the center of a users display. In block 610 if the virtual object has been selected, and optionally if the target site 444 is positioned to have its center align with a virtual object then: the object may be animated, the object may disappear, animation may occur around the object, an indication may be provided indicating an item having a name corresponding to the virtual object is removed from a list, the object may be moved or highlighted, or information may be provided about a room or a location where the virtual object exists in virtual space.

FIG. 7 depicts an example of a suitable computer environment 700 that includes a user interface which can provide a computer video game to a game player; the computer video game may include a game rendering and playing portion. Similar resources may use the computer environment and the processes as described herein.

The computer environment 700 illustrated in FIG. 7 is a general computer environment, which can be used to implement the game playing and rendering techniques as described herein. The computer environment 700 is only one example of a computer environment and is not intended to suggest any limitation as to the scope of use or functionality of the computer and network architectures. Neither should the computer environment 700 be interpreted as having any dependency or requirement relating to any one or combination of components illustrated in the exemplary computer environment 700.

The computer environment 700 includes a general-purpose computing device in the form of a computer 702. The computer 702 can be, for example, one or more of a stand alone computer, laptop computer, a networked computer, a mainframe computer, a PDA, a telephone, a microcomputer or microprocessor, or any other computer device that uses a processor in combination with a memory. The components of the computer 702 can include, but are not limited to, one or more processors or processing units 704, a system memory 706, and a system bus 708 that couples various system components including the processor 704 and the system memory 706.

The computer 702 can comprise a variety of computer readable media. Such media may be any available media that is accessible by the computer 702 and includes both volatile and non-volatile media, and removable and non-removable media. The process for playing and rendering the video game can be stored as instructions sets on the computer readable media.

The system memory 706 may include the computer readable media in the form of non-volatile memory such as read only memory (ROM) and/or volatile memory such as random access memory (RAM).

The computer 702 may also include other removable/non-removable, volatile/non-volatile computer storage media. By way of example, FIG. 7 illustrates a hard disk drive 715 for reading from and writing to a non-removable, non-volatile magnetic media (not shown), and an optical disk drive 717, for reading from and/or writing to a removable, non-volatile optical disk 724 such as a CD-ROM, DVD-ROM, or other optical media. The hard disk drive 715 and optical disk drive 717 may each be directly or indirectly connected to the system bus 708.

The disk drives and their associated computer-readable media provide non-volatile storage of computer readable instructions, program modules, and other data for the computer 702. Although the example depicts a hard disk within the hard disk drive 715, it is to be appreciated that other types of the computer readable media which can maintain for accessing data that is accessible by a computer, such as non-volatile optical disk drives, floppy drives, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computer environment 700.

Hard disk drive 715 may be a magnetic disk non-volatile optical disk, ROM and/or RAM. Stored on drive 715 including by way of example, may be an operating system (OS) 728, one or more video games 726, other program modules and program data.

A player can enter commands and information into the computer 702 via input devices 736 such as a keyboard and/or a pointing device (e.g., a “mouse”) which send a signal to the computer 702 in response to commands from the game player. Other input devices 736 (not shown specifically) may include a microphone, joystick, game pad, satellite dish, serial port, scanner, and/or the like. These and other input devices are connected to the processing unit 704 via input/output interfaces 740 that are coupled to the system bus 708, but may be connected by other interface and bus structures, such as a parallel port, game port, or a universal serial bus (USB).

A monitor, flat panel display, or other type of computer display 770 can also be connected to the system bus 708 via a video interface 744, such as a video adapter. In addition to the computer display 770, other output peripheral devices can include components such as speakers (not shown) which can be connected to the computer 702 via the input/output interfaces 740.

The computer 702 can operate in a networked environment using logical connections to one or more remote computers, such as a remote computer device 748. By way of example, the remote computer device 748 can be a personal computer, portable computer, a server, a router, a network computer, a peer device or other common network node, game console, and the like. The remote computer device 748 is illustrated as a server that can include many or all of the elements and features described herein relative to the computer 702.

Logical connections between the computer 702 and the remote computer device 748 are depicted as an Internet (or Intranet) 752 which may include a local area network (LAN) and/or a general wide area network (WAN). Video game 726 may be initially stored on Server 748 and be downloaded from internet 752 onto harddisk 715 in computer 702.

Various modules and techniques may be described herein in the general context of the computer-executable instructions, such as program modules, executed by one or more computers or other devices. Generally, program modules include routines, programs, control objects, components, control node data structures, etc. that perform particular tasks or implement particular abstract data types. Often, the functionality of the program modules may be combined or distributed as desired in various embodiments.

An implementation of the aforementioned computer video game may be stored on some form of the computer readable media (such as optical disk (724)) or transmitted from the computer media via a communications media to a user computer. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any process or technology for storage of information such as computer readable instructions, control node data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The term “communication media” includes, but is not limited to, computer readable instructions, control node data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

### Conclusion

The above-described apparatus and methods for creating and playing a computer implemented video game that simulates a 3D game play using 2D images. These and other techniques described herein may provide significant improvements over the current state of the art, potentially providing greater use of enabling video games to run on non 3D capable platforms. Although the system and method has been described in language specific to structural features and/or methodological acts, it is to be understood that the system and method defined in the appended claims is not necessarily limited to the specific features or acts described. Rather, the specific features and acts are disclosed as illustrative forms of implementing the claimed system and method.

1. A computer-implemented video game method comprising:
changing an apparent view of a portion of a two dimensional image to simulate a 360 degree panning in three dimensional virtual space in response to signals from a user input device; and
indicating, in response to signals from the user input device, a selection of displayed virtual objects layered on the portion of the two dimensional image.

2. The method of claim 1 wherein the 360 degree panning is simulated by panning along a vertical axis and a horizontal axis.

3. The method of claim 1 further comprising indicating additional displayed virtual objects overlaying another portion of the two dimensional image as the apparent view is changed.

4. The method of claim 1 wherein changing the apparent view of the two dimensional image to simulate a 360 degree panning enables an indication of walls, floors and ceiling in a room in the video game.

5. The method of claim 4 further comprising:
indicating a virtual control object simultaneously with the apparent view;
rotating the virtual control object at an angular velocity in response to signals from a user input device; and
changing the apparent view at a velocity proportionate to the angular velocity the virtual control object is rotated to simulate rotation of the room.

6. The method of claim 1 wherein the indication of the selection comprises selecting from the group consisting of: causing the object to be animated, causing the object to vanish, having animation occur around the object, indicating an item is removed from a list, moving the object, highlighting the object, or providing information about a room or a location where the virtual object exists in a virtual space.

7. The method of claim 1 further comprising:
displaying a target object layered over the portion of the two dimensional image;
indicating apparent movement of the target object with respect to the two dimensional image when the apparent view is changed; and
providing, with a change to the display of the target object, an indication of the target objects proximity in virtual space to one of the virtual objects.

8. The method as recited in claim 1 wherein the simulation of the 360 degree viewing simulates viewing the walls of a three dimensional (3d) object from the center of the 3d object, where the 3d object is selected from the group consisting of a sphere, a cylinder, a cube, cone an elliptical sphere, a pyramid, a rectangular cube or a multisided object having more than 6 sides.

9. The method as recited in claim 1 further comprising displaying a new virtual object after changing the apparent view that is not visible before changing the apparent view.

10. A computer readable medium comprising computer-executable instructions that, when executed by one or more processors, perform acts comprising:
changing, in a computer video game, an apparent view of a portion of a two dimensional image to simulate a panning in three dimensional virtual space in response to signals from a user input device; and
indicating, in response to signals from the user input device, a selection of displayed virtual objects layered on the portion of the two dimensional image.

11. The computer readable medium of claim 10, wherein the panning is simulated by panning along a vertical axis and a horizontal axis.

12. The computer readable medium of clam 10, wherein the acts further comprise indicating additional displayed virtual objects overlaid onto another portion of the two dimensional image as the apparent view is changed.

13. The computer readable medium of claim 10, wherein changing the apparent view of the two dimensional image to simulate panning enables an indication of walls, floors and ceiling in a room in the video game.

14. The computer readable medium of clam 10, wherein the acts further comprise:
indicating a virtual control object simultaneously with the apparent view;
rotating the virtual control object at an angular velocity in response to an indication from a user input device; and
changing the apparent view at a velocity proportionate to the angular velocity the virtual control object is rotated to simulate rotation of the room.

15. The computer readable medium of clam 10, wherein the indication of the selection comprises selecting from the group consisting of: causing the object to be animated, causing the object to vanish, having animation occur around the object, indicating an item is removed from a list, moving the object, highlighting the object, or providing information about a room or a location where the virtual object exists in a virtual space.

16. The computer readable medium of clam 10, wherein the acts further comprise:
displaying a target object layered over the portion of the two dimensional image;
indicating apparent movement of the target object with respect to a target site positioned on the two dimensional image when the apparent view is changed; and
providing, with a change to an apparent movement of the target object, an indication of the target object's proximity in virtual space to the target site.

17. The computer readable medium of clam 10, wherein the simulation of the 360 degree viewing simulates viewing the walls of a three dimensional (3d) object from the center of the 3d object, where the 3d object is selected from the group consisting of a sphere, a cylinder, a cube, cone an elliptical sphere, a pyramid, a rectangular cube or a multisided object having more than 6 sides.

18. The computer readable medium of clam 10, wherein the acts further comprise displaying a new virtual object after changing the apparent view that is not visible before changing the apparent view.

19. A computer-implemented video game method comprising:
creating a panorama of a plurality of two dimensional images;
mapping the panorama onto the walls of a three dimensional object;
viewing in the video game the mapped panorama on the walls of the three dimensional object from a position that is surrounded by the walls;
overlaying images of objects onto the walls;
changing, in a computer video game, an apparent view of a portion of the mapped panorama to simulate a panning in three dimensional virtual space in response to signals from a user input device; and
indicating, in response to signals from the user input device, a selection of displayed objects overlaid on walls.

20. The method as recited in claim 19 wherein the objects are overlaid onto the walls by overlaying the virtual objects on the two dimensional images prior to mapping; or wherein the objects are overlaid onto the walls by overlaying the objects directly onto the mapped walls.
